(19) United States
(12) Patent Application Publication
(10) Pub. No.: US 2018/0189100 A1
(43) Pub. Date: Jul. 5, 2018

(54) DISTRIBUTED COMPUTING SYSTEM

(71) Applicant: HITACHI, LTD., Tokyo (JP)

(72) Inventors: Jun NEMOTO, Tokyo (JP); Kaiho FUKUCHI, Tokyo (JP); Masakuni AGETSUMA, Tokyo (JP)

(73) Assignee: HITACHI, LTD., Tokyo (JP)

(21) Appl. No.: 15/860,216

(22) Filed: Jan. 2, 2018

(30) Foreign Application Priority Data
Jan. 5, 2017 (JP) 2017-000294

(51) Int. Cl. G06F 9/48; G06F 9/54

(52) U.S. Cl. CPC G06F 9/4831; G06F 9/542

(57) ABSTRACT

Reputation of a participant node is associated for each participant node which participates in a distributed computing system. The participant node updates reputation of a target node (any participant node) based on whether or not a result of execution of a task by the target node is correct and a degree of importance of a task corresponding to the result. A participant node which receives a request selects a participant node which is to be made a request destination of execution of a processing target task according to the request based on reputation of each participant node in processing of the request and transmits an approval request to the selected node (selected participant node).

### CROSS-REFERENCE TO PRIOR APPLICATION

This application relates to and claims the benefit of priority from Japanese Patent Application No. 2017-000294 filed on Jan. 5, 2017, the entire disclosure of which is incorporated herein by reference.

### BACKGROUND

The present invention generally relates to distributed computing.

In a distributed computing system, typically, computational tasks (hereinafter, referred to as “tasks”) are allocated. As a method for allocating tasks in the distributed computing system, there is a technique disclosed in US2009/0276519. According to the technique disclosed in US2009/0276519, tasks are allocated based on a monitoring result of a status of utilization of computational resources (a CPU, a memory, a network).

In the following description, a computer as an element of the distributed computing system is referred to as a “participant node”. Any computer having computational resources such as a processor, a memory and a communication interface device can be a participant node.

Further, in the following description, there is a case where an owner (or a user) of the participant node is referred to as a “participant”.

A distributed computing system in which unspecified computers can be participant nodes (hereinafter, referred to as a “participatory distributed system” for convenience sake) is known. As a typical example of the participatory distributed system, there is a decentralized distributed computing system such as a system to which a blockchain is applied.

Because the participant node is an unspecified computer, there can be a concern that miscalculation may occur by a participant node which is an allocation destination of a task or that intentional abuse may be performed by a malicious participant.

However, according to the technique disclosed in US2009/0276519, because all servers are assumed to be reliable servers and tasks are allocated only based on a monitoring result of a status of utilization of computational resources, it is impossible to alleviate the above-described concern regarding the participatory distributed system.

It can be considered that the above-described concern can be alleviated if reputation of participant nodes is known. However, technical means for appropriately determining reputation of participant nodes and securing believability of the reputation is unknown. While there can be a method in which a specific computer as a management computer manages participant nodes and determines reputation, the method cannot be applied to at least a system in which a management computer does not exist like a decentralized distributed computing system. Further, while there can be a method in which reputation of participant nodes is determined by humans, it is difficult to secure believability of the reputation of the participant nodes with this method because this method depends on a subjective view of humans.

### SUMMARY

A computer which participates in a distributed computing system executes

(A) requesting processing which is processing including the following (a1) to (a4) every time a request is received:
(a1) selecting one or more participant nodes which are to be made request destinations of execution of a task to be processed based on reputation respectively associated with participant nodes which participate in the distributed computing system and which are computers including the computer;
(a2) transmitting an approval request which is a request for executing the task to be processed to each of the selected one or more participant nodes;
(a3) accepting from each of the one or more participant nodes, an approval response which is a response to the approval request transmitted to the participant node and which is a response including a task execution result of the task to be processed executed by the participant node; and
(a4) returning a response to the above-described received request based on the number of matching task execution results, and
(B) reputation updating processing which is the following processing in at least one of the requesting processing and processing which is processing asynchronous with the requesting processing,
relatively increasing reputation associated with a participant node which transmits a response including a matching task execution result based on a degree of importance associated with a task corresponding to the task execution result.

According to the present invention, it is possible to improve reliability of a computational result in a distributed computing system in which unspecified computers can be participant nodes.

### BRIEF DESCRIPTION OF THE DRAWINGS

FIG. 1 is a block diagram illustrating a configuration of a distributed computing system according to Embodiment 1;

FIG. 2 is a block diagram illustrating an internal configuration of a blockchain program according to Embodiment 1;

FIG. 3 is a diagram illustrating a configuration of a server management table according to Embodiment 1;

FIG. 4 is a diagram illustrating a configuration of a smart contract management table according to Embodiment 1;

FIG. 5 is a flowchart illustrating an example of transaction processing according to Embodiment 1;

FIG. 6 is a flowchart illustrating an example of transaction approval processing according to Embodiment 1;

FIG. 7 is a flowchart illustrating an example of reputation updating processing according to Embodiment 1;

FIG. 8 is a block diagram illustrating an internal configuration of a blockchain program according to Embodiment 2;

FIG. 9 is a diagram illustrating a configuration of a server management table according to Embodiment 2;

FIG. 10 is a flowchart illustrating an example of settlement processing according to Embodiment 2; and

FIG. 11 is a schematic diagram illustrating outline of Embodiment 1.

### DETAILED DESCRIPTION OF THE EMBODIMENT

Some embodiments will be described below.

In the following description, while information will be described using expression of an “abc table”, the information may be expressed using a data configuration other than a table. To indicate that the information does not depend on the data configuration, at least one of the “abc table” can be referred to as “abc information”. Further, in the following description, a configuration of each table is an example, and one table may be divided into two or more tables, or all or part of two or more tables may be made one table.

Further, in the following description, an “interface unit” includes one or more interfaces. The one or more interfaces may be one or more interface devices of the same type (for example, one or more NICs (Network Interface Cards)) or may be two or more interface devices of different types (for example, an NIC and an HBA (Host Bus Adapter)).

Further, in the following description, a “storage unit” includes one or more memories. At least one memory may be a volatile memory or a non-volatile memory. The storage unit is mainly used for processing by a processor unit.

Further, in the following description, the “processor unit” includes one or more processors. At least one processor is typically a microprocessor such as a CPU (Central Processing Unit). Each of the one or more processors may be a single core or a multi core. The processor may include a hardware circuit which performs part or all of the processing.

Further, while, in the following description, there is a case where processing is described using a “program” as a subject, because the set processing is performed using a storage resource (for example, a memory) and/or a communication interface unit, or the like, as appropriate by the program being executed by a processor (for example, a CPU (Central Processing Unit)), the subject of the processing may be the processor unit. Processing described using the program as the subject may be processing performed by the processor unit or an apparatus having the processor unit. Further, the processor unit may include a hardware circuit which performs part or all of the processing. The program may be installed in an apparatus like a computer from a program source. The program source may be, for example, a program distributing server or a computer readable storage medium (for example, a non-transitory recording medium). Further, in the following description, two or more programs may be implemented as one program, or one program may be implemented as two or more programs.

Further, in the following description, in the case where description is provided without distinguishing elements of the same type, a reference numeral is used, and, in the case where description is provided while elements of the same type are distinguished, name as identification information of the elements is used.

### Embodiment 1

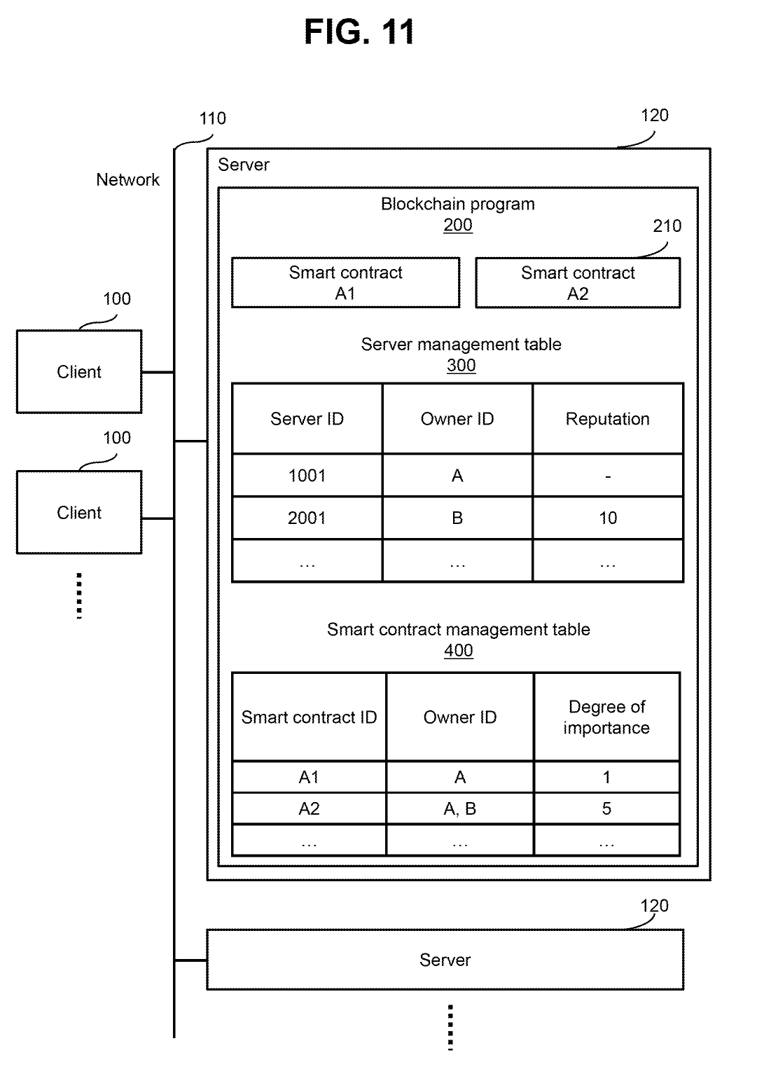

FIG. 11 illustrates outline of Embodiment 1.

A server 120 (an example of a participant node) which participates in a distributed computing system executes a blockchain program 200. The blockchain program 200 manages reputation of each server 120 and a degree of importance of each smart contract 210 (an example of a task). The blockchain program 200 updates reputation of a target server 120 (any server 120) based on whether or not a result of execution of the smart contract by the target server 120 is correct and a degree of importance associated with the smart contract 210 corresponding to the result. The blockchain program 200 of the server 120 which receives a request selects a server 120 which is to be made a request destination of execution of the smart contract 210 to be processed based on the reputation of each server 120 in processing of the request. Further, the blockchain program 200 acquires reputation (reputation of each server 120) managed by another server 120 (another server 120 different from the server 120 which executes the blockchain program 200) and updates reputation (reputation of each server 120) managed by the belonging server 120 (server 120 which executes the blockchain program 200) based on the acquired reputation.

Specifically, for example, the following procedure is performed.

At each server 120, the blockchain program 200 manages a server management table 300 including information indicating reputation of each server 120, a smart contract management table 400 including information indicating a degree of importance of each smart contract 210 and smart contracts A1 and A2.

A first server 120 (any server 120) receives a transaction request in which the smart contract A1 (an example of the smart contract 210 which is a processing target) is designated from a client 100.

The blockchain program 200 of the first server 120 executes the smart contract A1 according to the request.

Further, the blockchain program 200 of the first server 120 selects a given number of servers 120 in descending order of the reputation with reference to the server management table 300 managed by the program 200 and transmits a transaction approval request in which the smart contract A1 is designated to the selected servers 120 (selected servers 120). An example of the selected servers 120 is a second server 120. The blockchain program 200 of the second server 120 which receives the transaction approval request executes the smart contract A1 according to the request and returns a response including information indicating the execution result to a first node.

The blockchain program 200 of the first server 120 selects a correct smart contract execution result (for example, the most matching smart contract execution result) based on the smart contract execution results included in the responses from all the selected servers 120.

The blockchain program 200 of the first server 120 relatively increases the reputation of the server 120 which transmits the response of the smart contract execution result employed as a final result in accordance with a degree of importance of the smart contract A1.

The blockchain program 200 of each server 120 regularly mutually exchanges the server management tables 300 and reflects the server management table 300 of the other server 120 in the server management table 300 of the belonging server 120 (for example, sums the reputation).

Details of the present embodiment will be described below using the drawings.

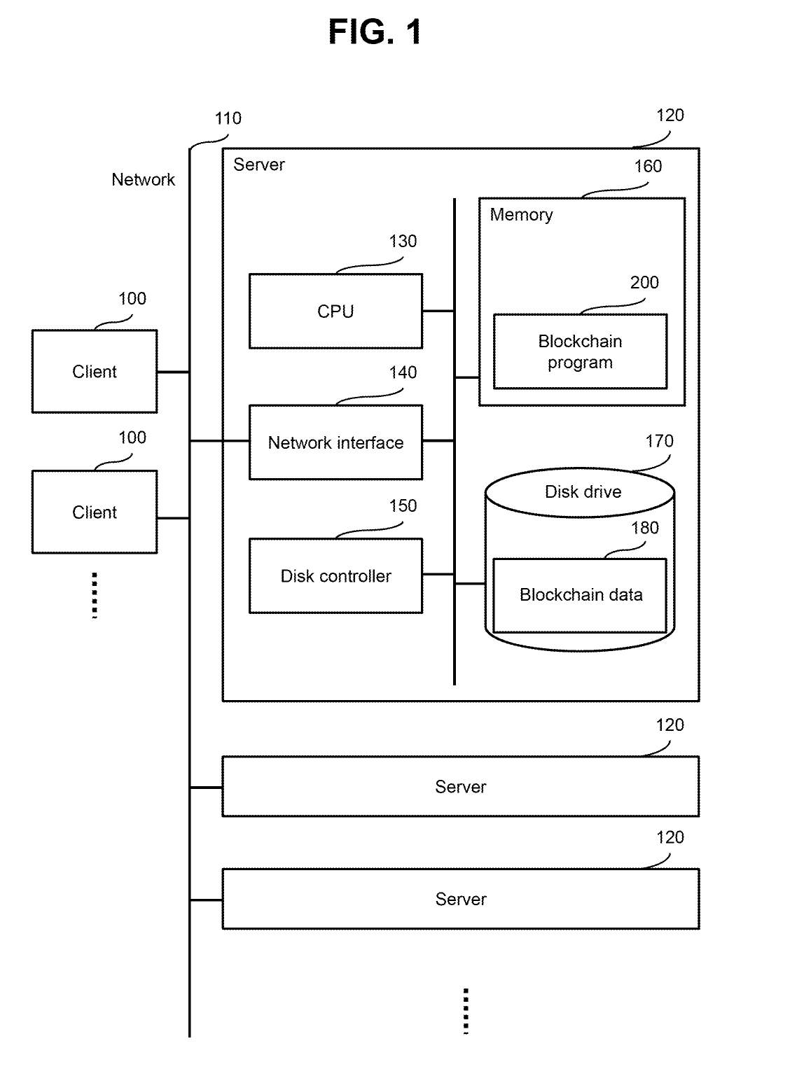

FIG. 1 is a block diagram illustrating a configuration of a distributed computing system according to Embodiment 1.

The distributed computing system includes one or more servers 120 coupled to one or more clients 100 via a network 110. Note that each of the one or more servers 120 may be owned by one subject or may be owned by a plurality of subjects.

The client 100 is a computer to be used to utilize distributed computing service provided by the one or more servers 120. At the client 100, a client program for utilizing the distributed computing service runs. The server 120 may be also used as the client 100 by making the client program run on the server 120.

The network 110 is a network which couples the client 100 and the server 120. The network 110 may be, for example, a LAN (Local Area Network) or a WAN (Wide Area Network).

The server 120 is a computer which provides the distributed computing service to the client 100. The server 120 is a computer in which a CPU 130 which executes a program stored in a memory 160, a network interface 140 to be used for communication with the client 100, a disk drive 170, a disk controller 150 which controls input/output to/from the disk drive 170, and a memory 160 which stores a program and data are mounted, and in which these are coupled via internal communication paths (for example, buses). The network interface 140 is an example of the interface unit. At least the memory 160 out of the memories 160 and 170 is an example of the storage unit. At least the CPU 130 out of the CPU 130 and the disk controller 150 is an example of the processor unit.

A program and data are stored in the memory 160 of the server 120. For example, the program is the blockchain program 200. The present embodiment will be described assuming that a subject which provides the distributed computing service is, for example, the blockchain program 200. In the following description, the distributed computing service by the blockchain program 200 will be referred to as blockchain service, and the distributed computing system which provides the blockchain service will be referred to as a blockchain system.

The blockchain program 200 serves a smart contract to the client 100 in cooperation with the blockchain program 200 at another server 120 and executes the smart contract based on the transaction request received from the client 100.

The disk controller 150 inputs/outputs data of the disk drive 170, for example, in units of block based on an input/output request of various programs stored in the memory 160.

The disk drive 170 is a storage device for storing data read/written by various programs stored in the memory 160. In the present embodiment, blockchain data 180 is stored in the disk drive 170.

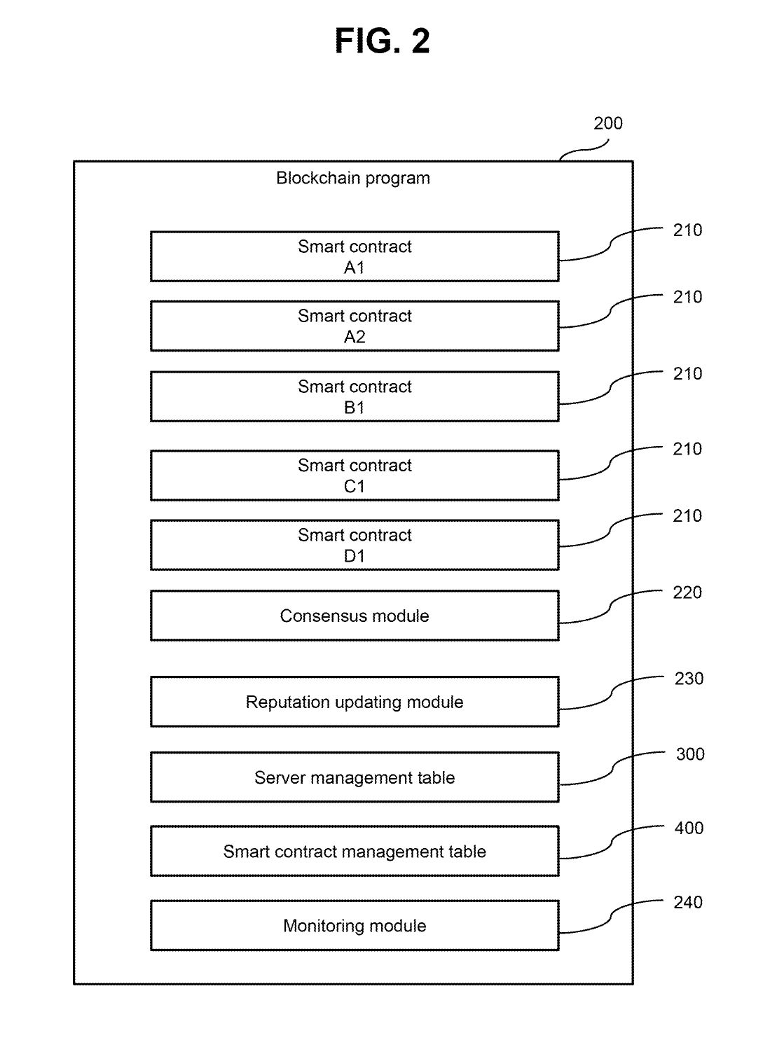

FIG. 2 is a block diagram illustrating an internal configuration of the blockchain program 200.

The blockchain program 200 includes one or more smart contracts 210, a consensus module 220, a reputation updating module 230 and a monitoring module 240. Further, the blockchain program 200 manages the server management table 300 and the smart contract management table 400.

The smart contract 210 is a program executed by the CPU 130 of the server 120. The smart contract 210 is, for example, a program for processing transaction of financial assets such as virtual currency and securities. In the blockchain program 200, a plurality of types of smart contracts can be provided by a plurality of subjects. The transaction corresponds to the smart contract 210 by 1:1, 1:N (where N is an integer equal to or larger than 2), M:1 (where M is an integer equal to or larger than 2) or M:N. The smart contract 210 is an example of the task.

The consensus module 220 is executed by the CPU 130 of the server 120 by being triggered by the transaction request from the client 100. The consensus module 220 receives the transaction request and executes the smart contract 210 corresponding to the request based on content of the transaction request. Further, the consensus module 220 transmits a transaction approval request to the consensus module 220 of another server 120 and returns a transaction processing result to the client 100 after achieving consensus with the another server 120 and deciding that the transaction processing result is correct. The same transaction processing is executed at a plurality of servers 120 because there is a possibility that, in the blockchain system which is participated in by unspecified number, a malicious participant may return an incorrect result or invalid data may be returned due to an error of hardware.

The reputation updating module 230 is executed by the CPU 130 of the server 120 based on an instruction from the participant or schedule defined in advance. The reputation updating module 230 acquires the server management table 300 from another server 120 which constitutes the blockchain system and updates the reputation of the server management table 300 of the belonging server based on the acquired server management table 300.

The server management table 300 is a table which manages reputation to be used as a criterion for selecting a server to which approval processing is to be requested, performance of the server 120, or the like, to achieve consensus regarding the transaction processing result. The server management table 300 is used by the consensus module 220 and the reputation updating module 230.

The smart contract management table 400 is a table which manages a degree of importance and consensus policy of the smart contract 210 provided in the blockchain program 200. The smart contract management table 400 is used by the consensus module 220.

The monitoring module 240 is regularly executed by the CPU 130 of the server 120 based on the schedule defined in advance. The monitoring module 240 acquires performance of each server 120 which participates in the blockchain system and updates information (a load 340 and delay 350 which will be described later) at the server management table 300 based on the performance of each server 120. Further, the monitoring module 240 acquires statistical information (for example, information indicating at least one of computational resources and computational time required for executing the smart contract) regarding an execution status of the smart contract for each of a plurality of smart contracts and updates information (a degree of importance 430 which will be described later) at the smart contract management table 400 based on the statistical information.

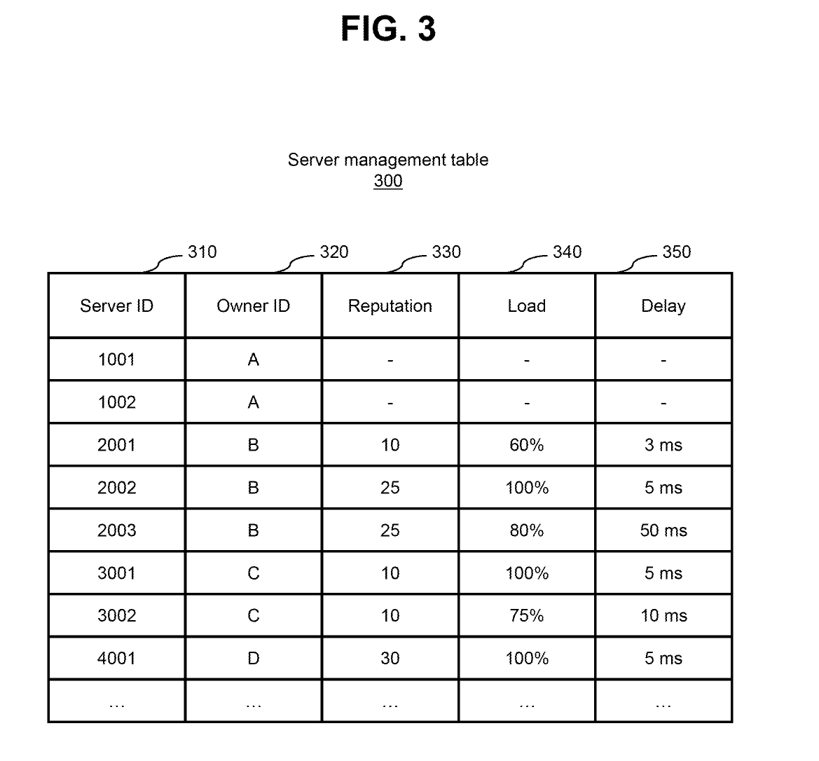

FIG. 3 is a diagram illustrating a configuration example of the server management table 300.

The server management table 300 has an entry (record) for each server 120, and each entry holds information such as a server ID 310, an owner ID 320, reputation 330, a load 340 and delay 350.

The server ID 310 is identification information of the server. The owner ID 320 is identification information of a subject which owns the server 120. The reputation 330 is a value indicating reputation of the server 120. A higher value indicates higher reputation. The load 340 indicates a load of the server 120. The delay 350 indicates delay in communication between the own server 120 and another server 120.

The owner ID 320, the reputation 330, the load 340 and the delay 350 are used by the consensus module 220 to select a server 120 to which transaction approval processing is to be requested.

A degree of importance 430 of the smart contract which will be described later and whether the server 120 returns a correct result in the transaction approval processing are reflected in the reputation 330. That is, correctness of behavior of another server 120 is reflected in the reputation 330 regardless of whether there is abuse by a human such as a malicious participant or an error which is generated by not a human but hardware or software.

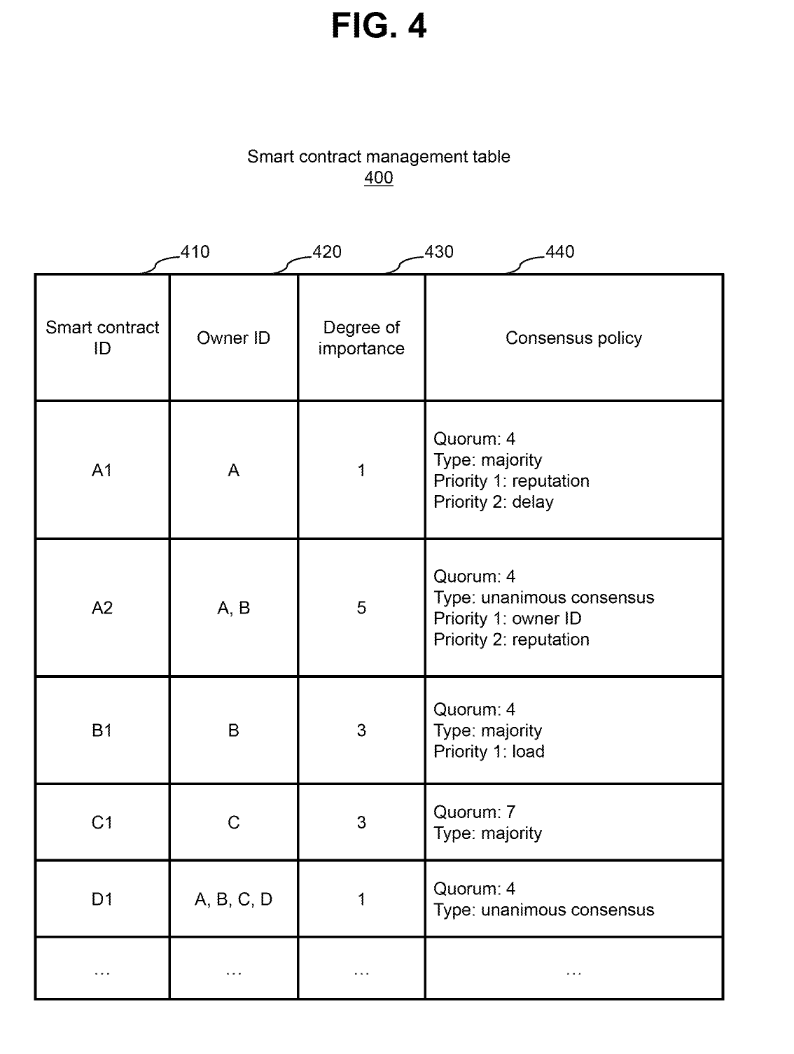

FIG. 4 is a diagram illustrating a configuration example of the smart contract management table 400.

The smart contract management table 400 holds information such as a smart contract ID 410, an owner ID 420, a degree of importance 430 and a consensus policy 440 for each smart contract 210.

The smart contract ID 410 is identification information of the smart contract 210. The owner ID 420 is identification information of a subject which owns the smart contract 210. The degree of importance 430 is a value indicating a degree of importance of the smart contract 210. A higher value indicates a higher degree of importance. The consensus policy 440 indicates a policy for selecting a server 120 to which transaction approval processing is to be requested.

The owner ID 420 is used to determine the reputation 330 in processing by the consensus module 220 and to select a server 120 to which transaction approval processing is to be requested. As illustrated in FIG. 4, the smart contract 210 may be owned by a plurality of subjects.

As described above, the degree of importance 430 is a value indicating a degree of importance of the smart contract 210, and is, for example, based on a relative value for at least one of computational resources and computational time required for executing the smart contract 210 (a value based on a comparison result of at least one of computational resources and computational time for each of other smart contracts 210). In this case, the monitoring module 240 may monitor computational resources and computational time required for executing each smart contract 210 and determine (update) the degree of importance 430 of the smart contract 210 based on the monitoring result. In the degree of importance 430, in place of or in addition to such automatic addition (updating), importance or confidentiality of transaction of the smart contract 210 may be reflected (for example, a value as the degree of importance 430 may be a value itself which is arbitrarily determined by a subject which owns the smart contract 210 or a value in which the value is taken into account).

The consensus policy 440 is formed with, for example, a “quorum” which is the number of servers 120 to which transaction approval processing is to be requested, a “type” as to how to achieve consensus, such as unanimous consensus and majority and an “item” to be prioritized when the server 120 is selected. Note that there may be a plurality of items to be prioritized when the server 120 is selected. Further, in the case where there is no designated item to be prioritized, any item such as, for example, the reputation may be prioritized by default. As the “item”, at least one of the owner ID of the server 120, the load of the server 120, the degree of importance 430 of the smart contract 210 and the delay (communication delay) of the server 120 can be employed.

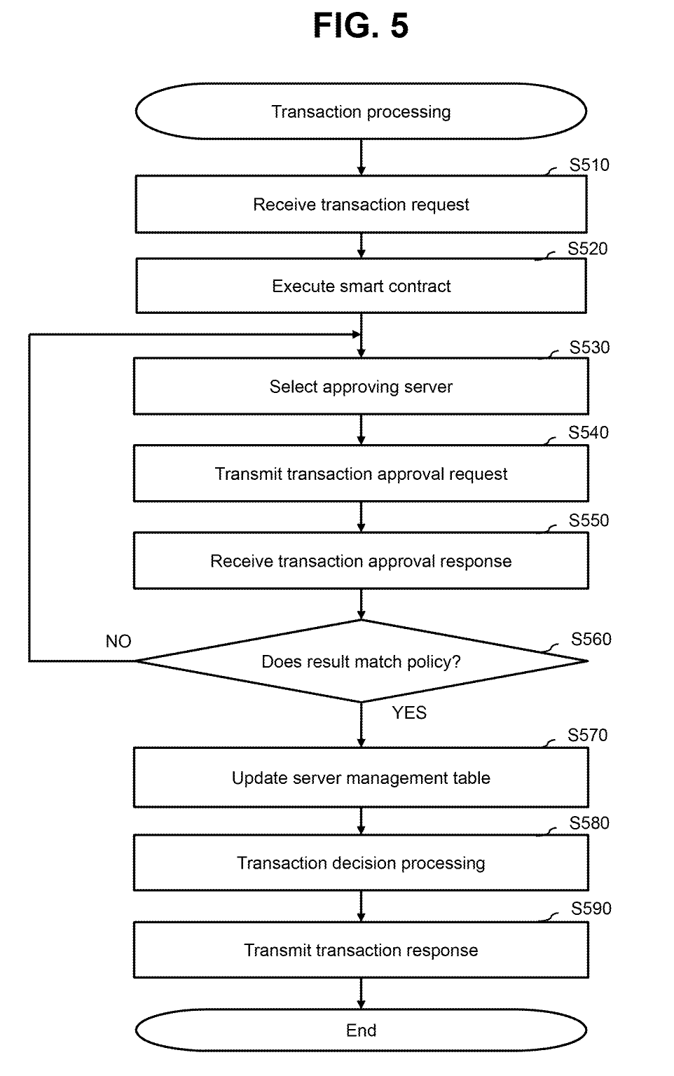

FIG. 5 is a flowchart illustrating an example of the transaction processing. The transaction processing is executed by being triggered by a transaction request from the client 100 (client program). Note that the consensus module 220 in the description of FIG. 5 may be a consensus module 220 of any server 120.

First, the consensus module 220 receives a transaction request from the client 100 (S510). The transaction request includes a smart contract ID of a target smart contract and a parameter to be designated when the smart contract is executed.

The consensus module 220 then executes the smart contract 210 corresponding to the smart contract ID included in the transaction request (S520). Here, the consensus module 220 evacuates an execution result of the smart contract 210, that is, a return value and data to be reflected in the blockchain data 180, to the memory 160 to be used in the processing which will be described later.

The consensus module 220 then selects a server 120 which is to be made a request destination of the transaction approval processing with reference to the server management table 300 and the smart contract management table 400 (S530). Specifically, first, the consensus module 220 acquires a quorum and an item to be prioritized with reference to the consensus policy 440 corresponding to the ID 410 of the smart contract 210 which is a processing target. The consensus module 220 then selects servers 120 of the number corresponding to the quorum based on the item to be prioritized with reference to the server management table 300.

For example, in the case where the smart contract 210 which is the processing target is the smart contract A1, according to the consensus policy 440 of the smart contract A1, the quorum is “4”, and the reputation 330 is an item to be most prioritized, and the delay 350 is an item to be second most prioritized. Therefore, the consensus module 220 selects servers 120 in descending order of the reputation 330. The servers 120 selected here are a server “4001” with the highest reputation 330, and servers “2002” and “2003” with the second highest reputation 330. The consensus module 220 then selects a server “2001” with the smallest delay 350 among servers with equal (third highest) reputation 330. As a result, servers 120 of the number corresponding to the quorum “4” are selected. Note that the consensus module 220 may select servers of the number matching the quorum by selecting servers according to an item with relatively higher priority and excluding servers according to an item with relatively lower priority from the selected servers.

Further, for example, in the case where the smart contract 210 which is the processing target is the smart contract A2, according to the consensus policy of the smart contract A2, the quorum is “4”, the owner ID 320 is an item to be most prioritized, and the reputation 330 is an item to be second most prioritized. Therefore, the consensus module 220 selects servers “2001”, “2002” and “2003” owned by the owner B of the smart contract A2. The consensus module 220 then selects a server “4001” with the highest reputation 330 among servers owned by persons other than the owner B.

Further, for example, in the case where the smart contract 210 which is the processing target is the smart contract B1, according to the consensus policy of the smart contract B1, an item to be prioritized is the load 340. Therefore, the consensus module 220 selects servers 120 in ascending order of the load 340. In the case where the servers 120 are selected while the load 340 is taken into account, the consensus module 220 may also take into account the degree of importance 430 of the smart contract B1. The degree of importance 430 is a value in which computational resources and computational time required for executing each smart contract are reflected. By the consensus module 220 selecting servers 120 while also taking into account the degree of importance 430 in which an execution status of each smart contract reported from the monitoring module 240 is reflected, it is possible to prevent processing from being delayed as a result of the load of the server 120 to which the transaction approval processing is requested becoming an overload.

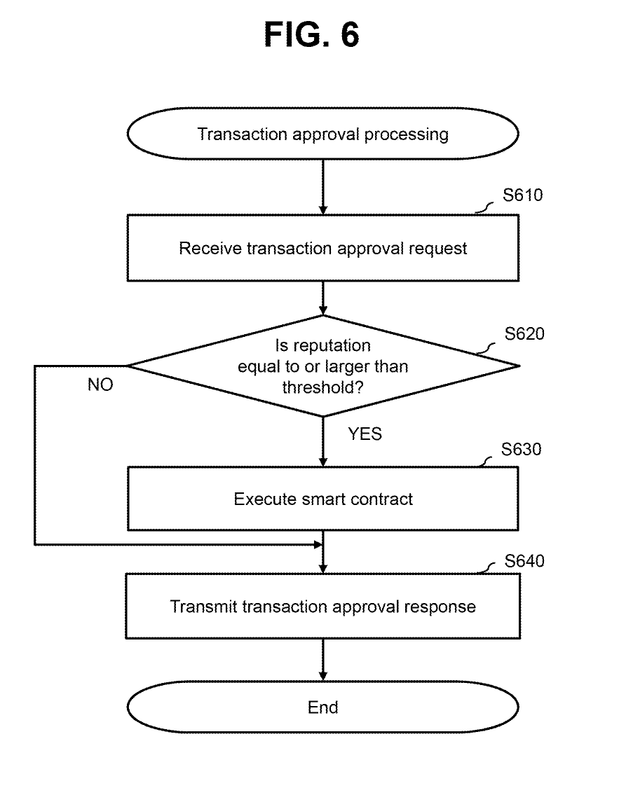

After S530, the consensus module 220 transmits a transaction approval request to the servers (hereinafter, referred to as “selected servers” in the description of FIG. 5 and FIG. 6) 120 selected in S530 (S540). Details of the transaction approval processing will be described later.

When the selected servers 120 return transaction approval responses, the consensus module 220 receives the transaction approval responses (S550).

The consensus module 220 which receives the transaction approval responses takes a vote by comparing the smart contract execution result evacuated in S520 and smart contract execution results included in the transaction approval responses, and judges whether or not the result matches the “type” in the consensus policy 440 corresponding to the smart contract 210 which is the processing target (S560). For example, in the consensus policy 440, the “type” indicates conditions such as “majority” (majority of the servers of the quorum) and “unanimous consensus” (all the servers of the quorum). The conditions are conditions (criterion) for regarding distributed processing results of the smart contract (results of the transaction approval processing requested to all the selected servers 120 (execution results of smart contracts)) as correct results. Specifically, the conditions correspond to, for example, conditions of the number of servers 120 in which execution results of the smart contracts match (the number of matching smart contract execution results). For example, in the case where the “type” is “majority”, the smart contract execution results among which majority of the execution results matches are correct smart contract execution results.

In the case where the judgment result of S560 is true (S560: Yes), the consensus module 220 updates the server management table 300 (S570). Specifically, the consensus module 220 relatively increases the reputation 330 corresponding to a server 120 which returns the smart contract execution result (matching smart contract execution result) adopted in S560 based on the degree of importance 430 of the smart contract 210. “Relatively increasing the reputation 330” may be, for example, adding the value of the degree of importance 430 of the smart contract 210 which is the processing target to the reputation 330 corresponding to the server 120 which returns the adopted smart contract execution result, or, in place of or in addition to this, subtracting the value of the degree of importance 430 of the smart contract 210 which is the processing target from the reputation 330 corresponding to the server 120 which returns a smart contract execution result different from the adopted smart contract execution result. Note that in the case where a server 120 which executes the consensus module 220 or a server 120 owned by the same subject as the subject which owns the smart contract 210 which is the processing target is always reliable, the reputation 330 of the server 120 may be exempt from addition or may be always made a target of addition. Further, in the case where a smart contract owned by a plurality of subjects like the smart contract A2 is the smart contract which is the processing target, the reputation 330 of any server 120 may be exempt from addition. Further, updating processing of the server management table 300 may be performed after the smart contract 210 for the updating processing of the server management table 300 is prepared and consensus with two or more servers 120 is achieved as an execution result of the smart contract 210 for the updating processing.

As described above, because the reputation 330 of the server 120 which outputs the matching smart contract execution result is updated according to the value of the degree of importance 430 of the smart contract 210, it is possible to improve believability of the reputation 330.

In the case where the judgment result of S560 is false (S560: No), the consensus module 220 selects again a server which is to be made a request destination of the transaction approval processing (S530). At this time, the consensus module 220 may exclude a server 120 which returns a different smart contract execution result in S560 from candidates for the server 120 which is to be made a request destination.

After the server management table 300 is updated, the consensus module 220 executes transaction decision processing (S580). Specifically, the consensus module 220 notifies each selected server 120 of decision of the transaction, and each selected server 120 which receives the notification reflects the smart contract execution result evacuated in the memory 160 of the selected server 120 in the blockchain data 180 in the server 120. Note that the consensus module 220 transmits the smart contract execution result which is adopted in S560 to a server 120 which returns the smart contract execution result which is not adopted in S560 (erroneous smart contract execution result), and the server 120 reflects the smart contract execution result in the blockchain data 180.

The consensus module 220 then transmits a transaction response to the client 100 which is a transmission source of the above-described transaction request (S590). The transaction response includes the smart contract execution result.

FIG. 6 is a flowchart illustrating an example of the transaction approval processing. The transaction approval processing is executed by being triggered by a transaction approval request from the server 120. The processing of FIG. 6 will be described below using an example of one selected server 120 which receives a transaction approval request from the server 120 which executes the consensus module 220 in FIG. 5. That is, the consensus module 220 in FIG. 6 is a consensus module 220 to be executed at the selected server 120. Therefore, the consensus module 220 at any server 120 can execute processing of FIG. 5 and FIG. 6. Further, in the present embodiment, it is assumed that all blockchain programs 200 access information within the server 120 which executes the programs 200 and does not directly access information within other servers 120. Note that execution of the smart contract 210 according to the transaction approval request can be referred to as “endorsement”, and an owner (participant) of the server 120 which receives the transaction approval request can be referred to as a “endorser”.

First, the consensus module 220 receives the transaction approval request from the server 120 (S510). The transaction approval request includes a smart contract ID of the smart contract which is the processing target and a parameter to be designated when the smart contract is executed.

The consensus module 220 then judges whether the reputation 330 of the server 120 which is a transmission source of the transaction approval request is equal to or larger than a threshold defined in advance with reference to the server management table 300 (S620). The threshold may be, for example, designated by the owner of the selected server 120. The threshold may be a value different for each server 120.

In the case where the judgment result of S620 is true (S620: Yes), the consensus module 220 executes the smart contract 210 corresponding to the smart contract ID included in the transaction approval request (S630). Here, the consensus module 220 evacuates the execution result of the smart contract, that is, data to be reflected in a return value and the blockchain data 180, in the memory 160 to be used in the transaction decision processing.

The consensus module 220 then transmits a transaction approval response to the server 120 which is a transmission source of the transaction approval request (S640). The transaction approval response includes the smart contract execution result.

In the case where the judgment result of S620 is false (S620: No), the consensus module 220 transmits the transaction approval response including information meaning failure of smart contract execution to the server 120 which is a transmission source of the transaction approval request (S640). That is, in the case where the consensus module 220 receives the transaction approval request from the server 120 whose reputation 330 is smaller than the threshold, the consensus module 220 returns a response meaning failure without executing the smart contract. By this means, even if transaction approval requests have to be transmitted to the servers 120 of the number corresponding to the quorum, it is possible to avoid a situation where the distributed processing result of the smart contract becomes a correct result by responding to a request from a server 120 with low reputation 330. Note that the consensus module 220 may perform no response instead of returning a response meaning failure. Further, in the case where servers 120 of the number corresponding to the quorum cannot be selected unless servers 120 whose reputation 330 is smaller than the threshold are selected, the consensus module 220 does not have to select servers 120 whose reputation 330 is smaller than the threshold, that is, the number of the selected servers 120 may be less than the quorum.

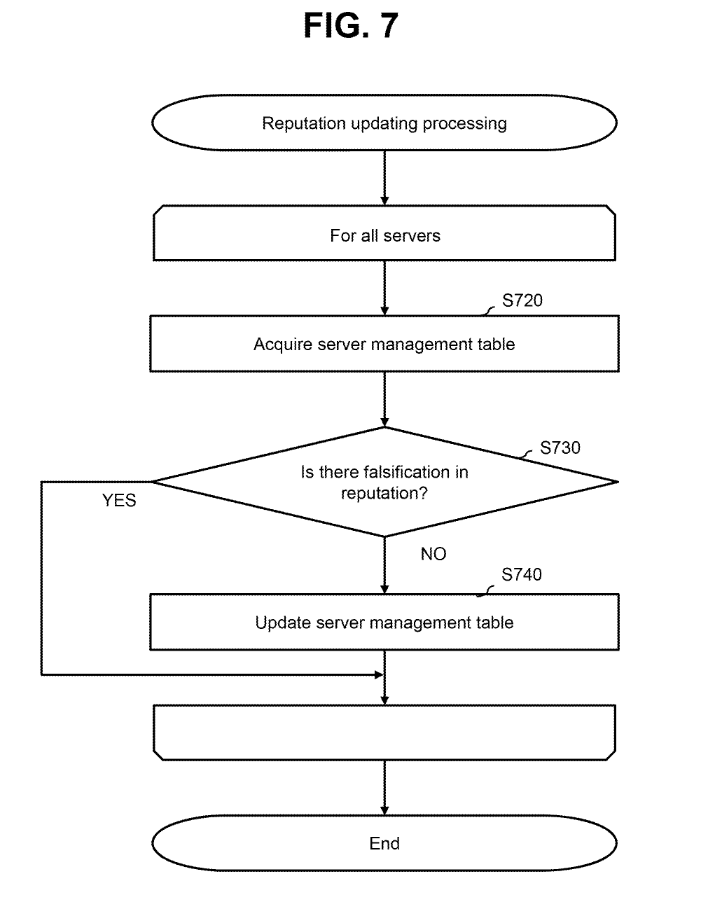

FIG. 7 is a flowchart illustrating an example of reputation updating processing. The reputation updating processing is executed based on an instruction from a participant (typically, an owner) or schedule defined in advance.

The reputation updating module 230 executes processing from S720 to S740 for all the servers 120. Specific processing from S720 to S740 will be described using an example of one server 120.

First, the reputation updating module 230 acquires the server management table 300 from the server 120 (S720).

The reputation updating module 230 then judges whether or not there is falsification for each reputation 330 in the server management table 300 acquired in S720 (S730). Specifically, in verification of the reputation 330, the reputation updating module 230 confirms that the server 120 which is an acquisition source of the server management table 300 does not falsify the reputation 330 with reference to blocks in the blockchain data 180. Because verifying all data is inefficient, an appropriate number of blocks may be sampled and confirmed. Alternatively, as described above, updating of the reputation 330 may be executed as a smart contract, and the present processing may be skipped in the case where consensus is achieved between servers.

In the case where the judgment result of S730 is false (S730: No), the reputation updating module 230 updates the server management table 300 of the belonging server 120 (server 120 which executes the reputation updating module 230) based on the acquired server management table 300 (S740). Specifically, for example, the reputation updating module 230 simply sums the reputation 330 or corrects the server management table 300 based on variation of the reputation 330 among servers 120.

In the case where the judgement result of S730 is true (S730: Yes), the reputation updating module 230 discards the acquired server management table 300 (S750).

As described above, according to the present embodiment, the reputation 330 of the server 120 which participates in the blockchain system is determined based on the degree of importance 430 of the smart contract 210 and whether the distributed processing result of the smart contract 210 is correct or wrong. While it depends on the consensus policy 440 corresponding to the smart contract 210 which is the processing target, it is possible to select a server 120 which is made a request destination of the transaction approval processing based on the determined reputation 330. Therefore, in a blockchain system in which unspecified servers can be participant nodes, it is possible to improve reliability of the smart contract execution result.

Further, according to the present embodiment, each server 120 acquires the reputation 330 managed by other servers 120 and updates the reputation 330 managed by the belonging server 120 based on the acquired reputation 330. Therefore, it is possible to avoid a problem that a certain participant behaves abusively only toward a specific participant, so that it is possible to improve reliability of the whole system.

Further, according to the present embodiment, a transaction approval request from a server 120 with a low reputation 330 is not processed. By this means, because incentive for improving believability of the reputation 330 acts, it is possible to improve reliability of the whole system.

Note that, while the reputation 330 is updated by the degree of importance 430 being simply added to simplify description of the present embodiment, for example, another calculation method (updating method) such as weighted averaging of percentages of transaction answered correctly with the degree of importance 430 may be used.

### Embodiment 2

Embodiment 2 will be described below using the drawings. Differences with Embodiment 1 will be mainly described below, and description regarding points in common with Embodiment 1 will be omitted or simplified.

In Embodiment 2, to maintain incentive for performing the transaction approval processing, reputation management in Embodiment 1 is extended.

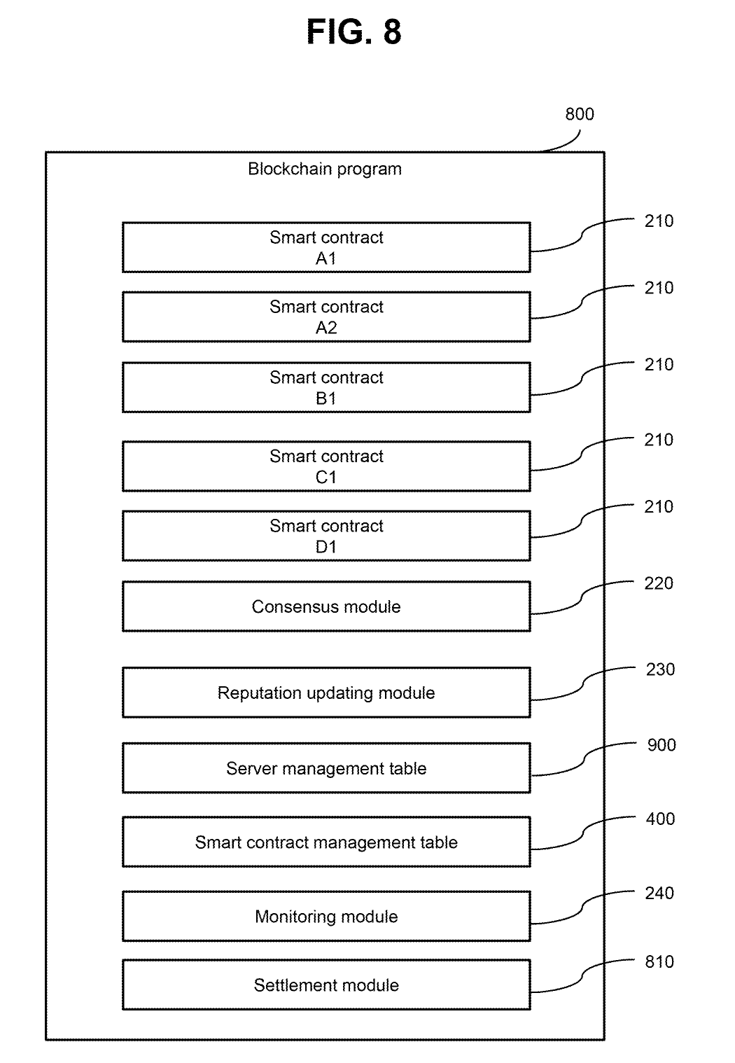

FIG. 8 is a block diagram illustrating an internal configuration of a blockchain program 800 according to Embodiment 2.

The blockchain program 800 further includes a settlement module 810. The settlement module 810 is executed by the CPU 130 based on an instruction from a participant (typically, an owner) or schedule defined in advance. The settlement module 810 performs settlement processing of, for example, virtual currency, or the like, according to unprocessed reputation 910 which will be described later.

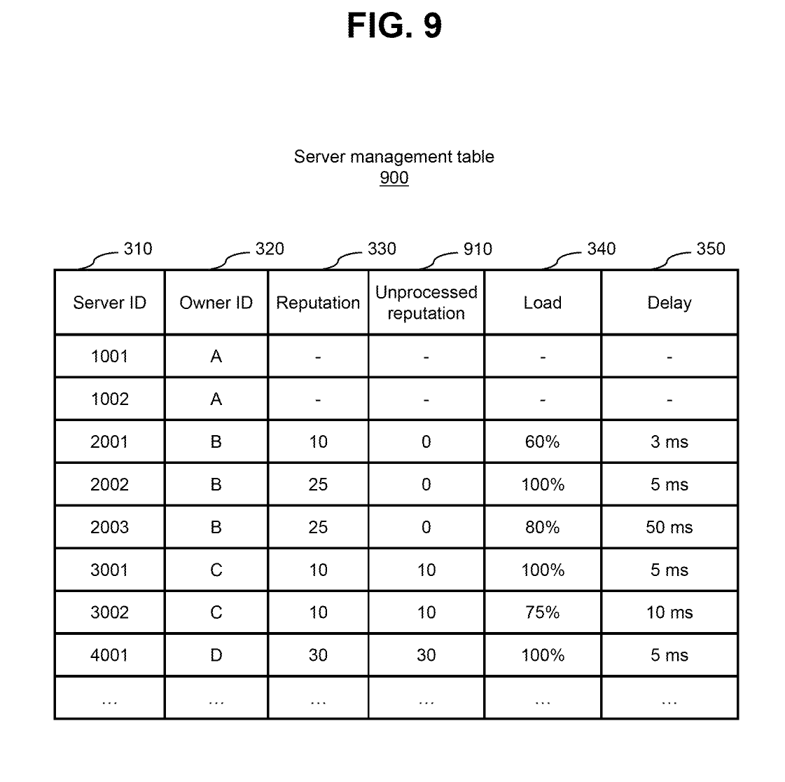

FIG. 9 is a diagram illustrating a configuration example of a server management table 900 according to Embodiment 2.

Each entry in the server management table 900 further holds unprocessed reputation 910. The unprocessed reputation 910 is temporal information regarding reputation from when the previous settlement processing is executed for the unprocessed reputation 910 (when the unprocessed reputation 910 is returned to an initial value) until now, and is a value according to how many times transaction approval processing is correctly executed from when the previous settlement processing is executed until now (the number of returned matching smart contract execution results). In the transaction processing of the present embodiment, the consensus module 220 updates the unprocessed reputation 910 (reflects whether a correct result is returned in the transaction approval processing in the unprocessed reputation 910) in place of the reputation 330 in S570 (updating of the server management table 900). S530 (selection of servers 120) is performed based on the reputation 330 as with the case of Embodiment 1.

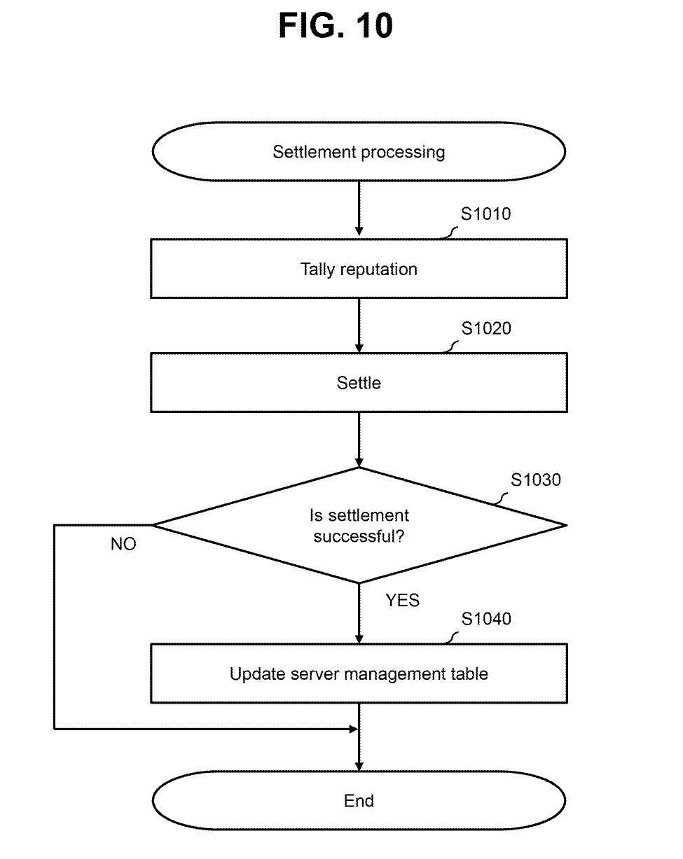

FIG. 10 is a flowchart illustrating an example of the settlement processing. The settlement processing is executed based on an instruction from a participant or schedule defined in advance and uses an owner ID as a parameter.

First, the settlement module 810 tallies the unprocessed reputation 910 corresponding to the owner ID designated as a parameter with reference to the server management table 900 (S1010). Here, tallying is, for example, totaling.

The settlement module 810 then makes settlement based on a value obtained through tallying in S1010 (S1020). Here, “settlement” indicates payment of some kind of a reward (reward based on the value obtained through tallying in S1010) to a subject corresponding to the owner ID. The “reward” is, for example, virtual currency, and a smart contract in the blockchain system in the present embodiment may be used. Alternatively, payment may be performed using physical currency through coupling to other settlement systems. As the “reward”, a target other than currency (virtual currency or physical currency) may be employed.

The settlement module 810 then judges whether or not the settlement is successful (S1030).

In the case where the judgment result of S1030 is true (S1030: Yes), the settlement module 810 initializes the value of the unprocessed reputation 910 (for example, sets “0” for resetting the value of the unprocessed reputation 910) after reflecting (for example, adding) the value of the unprocessed reputation 910 in the reputation 330 for the server 120 corresponding to the owner ID.

In the case where the judgment result of S1030 is false (S1030: No), the settlement processing is finished.

Note that, in the present embodiment, considering property of “settlement” of virtual currency, or the like, it is assumed that the unprocessed reputation 910 is updated after consensus is achieved between the servers 120, and whether or not the unprocessed reputation 910 is falsified does not have to be judged.

Further, while, in the present embodiment, settlement is made through batch processing using the unprocessed reputation 910, to reflect the unprocessed reputation 910 in the reputation 330 more quickly and more accurately, settlement and updating of the reputation 330 may be performed for each transaction processing.

As described above, according to the present embodiment, it is possible to maintain incentive for performing transaction approval processing through settlement based on the unprocessed reputation 910. Therefore, as a result, it is possible to improve reliability of the whole blockchain system.

While it is expected that incentive for participating in the blockchain system according to the present embodiment is maintained and participants (servers 120 as participant nodes) are increased by appropriate rewards being appropriately paid to the participants, the main significance of the present embodiment lies in securing believability of the reputation 330 of the server 120 as with the case of Embodiment 1. In Embodiment 2, unprocessed reputation 910 indicating how many transaction approval responses including matching smart contract execution results are returned from when the previous settlement processing is executed until now is introduced, and the unprocessed reputation 910 is updated after consensus is achieved between the servers 120, and is reflected in the reputation 330 when the settlement is successful. Therefore, it is expected that believability of the reputation 330 is improved compared to that in Embodiment 1.

Embodiments 1 and 2 have been described above.

According to one comparative example, believability of a participatory distributed system, that is, a distributed computing system in which unspecified computers can participate as participant nodes (for example, a decentralized distributed computing system) is low. Because participant nodes are unspecified computers, there can be a concern that a miscalculation may occur by a participant node which is a request destination (allocation destination) of approval (endorsement) of the smart contract or that intentional abuse may be performed by a malicious participant.

Executing the smart contract corresponding to transaction among a plurality of parties by a participant node of at least one participant other than the parties in addition to participant nodes of the parties leads to increase in reliability of the transaction. That is, increase of participants as endorsers improves reliability of transaction in the participatory distributed system. If there is no endorser, justice of the transaction is closed among the parties. Therefore, it is impossible to perform new flexible transaction in which a plurality of subjects and a plurality of smart contracts are combined.

Technology development such as a smart contract involving coordination between different types of systems such as a logistics system and a healthcare system, and IoT (Internet of Things) and AI (Artificial Intelligence) directed to realizing autonomous distributed organization is desired to realize a use case supporting social infrastructure in the future. One means to realize this use case is to improve reliability of a verification result indicating that a smart contract is implemented correctly as required and that abuse is not performed. To realize this, it is necessary to increase participants, specifically, increase approvers (for example, endorsers) of the smart contract. To increase participants, there is a method in which reliability of the participatory distributed system is increased so that a new subject can be a participant without feeling anxiety and existing participants can remain to be participants without feeling anxiety.

Therefore, the technical means described in Embodiments 1 and 2 contributes to improvement of reliability of the blockchain system (an example of the participatory distributed system) which has been an issue, and thus, contributes to realization of the above-described use case which supports social infrastructure in the future. This is one technical meaning of providing the above-described technical means.

Further, in both of the above-described Embodiments 1 and 2, the degree of importance of the smart contract 210 is based on at least one of the computational resources and computational time required for executing the smart contract 210. The reputation of the server 120 is updated based on the degree of importance of the smart contract 210, and the server 120 as a transmission destination of the transaction approval request is selected based on the reputation of the server 120. Therefore, it is expected that a processing load is distributed (for example, requesting of execution of the smart contract 210 with a high load to a server 120 with low performance is avoided) while maintaining increase in reliability of the participatory distributed system.

A difference in reputation between the servers 120 is a difference in degrees of contribution of respective servers 120 to consensus. Therefore, the blockchain program 200 of the server 120 may execute settlement processing of paying a reward to a designated participant based on the reputation associated with the server 120 owned by the participant (for example, a difference between a value obtained by tallying the reputation of the server 120 of the designated participant and a value obtained by tallying the reputation of the servers 120 owned by other participants). A specific example of the settlement processing has been described in description of Embodiment 2.

While some embodiments have been described above, these are examples for explaining the present invention, and are not intended to limit the scope of the present invention only to the embodiments. The present invention can be implement in other various forms.

For example, the reputation associated with the participant node such as the server 120 may be reputation of an owner of the participant node or reputation of a user of the participant node in place of or in addition to the reputation of the participant node itself.

Further, for example, in the transaction processing in FIG. 5, S520 may be skipped. That is, the own server 120 (the server 120 which executes the consensus module) dose not always have to execute the smart contract 210 which is the processing target.

Further, for example, the server management table 300 managed by the blockchain program 200 of each server 120 may include breakdown of the reputation 330 of each server 120. The breakdown of the reputation 330 of the server 120 may include an ID of the smart contract from which a correct smart contract execution result can be obtained among smart contracts executed by the server 120, and reputation according to the execution result (hereinafter, a sub-reputation). The blockchain program 200 of the server 120 may determine a reward based on a difference between a value obtained by tallying the sub-reputation of a participant X (participant who owns the server 120) and a value obtained by tallying the sub-reputation of a participant Y (designated participant). The reward may be plus (a reward is paid from the participant X to the participant Y) or minus (a reward is paid from the participant Y to the participant X). The reward may be either plus or minus in a similar manner in the settlement processing in Embodiment 2 or other settlement processing.

What is claimed is:

1. A non-transitory computer readable medium storing a computer program causing a computer which participates in a distributed computing system to execute
(A) requesting processing which is processing including the following (a1) to (a4) every time a request is received:
(a1) selecting one or more participant nodes which are to be made request destinations of execution of a processing target task based on reputation respectively associated with participant nodes which participate in the distributed computing system and which are computers including the computer;
(a2) transmitting an approval request which is a request for executing the processing target task to each of the selected one or more participant nodes;
(a3) accepting from each of the one or more participant nodes, an approval response which is a response to the approval request transmitted to the participant node and which is a response including a task execution result of the processing target task executed by the participant node; and
(a4) returning a response to the request based on the number of correct task execution results, and
(B) reputation updating processing which is the following processing in at least one of the requesting processing and processing asynchronous with the requesting processing,
relatively increasing reputation associated with a participant node which transmits a response including a correct task execution result based on a degree of importance associated with a task corresponding to the task execution result.

2. The non-transitory computer readable medium according to claim 1,
wherein the reputation updating processing includes the following (b1) and (b2):
(b1) in the case where a response including a correct task execution result is received from a participant node in the requesting processing for each of the one or more participant nodes, relatively increasing unprocessed reputation associated with the participant node,
for each participant node, the associated unprocessed reputation being a value according to the number of matching task execution results returned after the unprocessed reputation is returned to an initial value; and
(b2) in processing asynchronous with the requesting processing, reflecting at least one piece of unprocessed reputation in reputation associated with a participant node with which the unprocessed reputation is associated.

3. The non-transitory computer readable medium according to claim 2,
wherein the asynchronous processing is settlement processing which is processing of paying to a designated participant a reward based on a tallied value obtained by tallying unprocessed reputation associated with a participant node of the participant,
the at least one piece of unprocessed reputation is the tallied value, and
reflection in (b2) is reflection of the tallied value in reputation associated with the participant node of the designated participant.

4. The non-transitory computer readable medium according to claim 1,
wherein the computer program further causing the computer to execute
(C) monitoring processing which is processing which is asynchronous with the requesting processing and which includes the following (c1) and (c2):
(c1) for each of a plurality of tasks including the processing target task, monitoring at least one of computational resources and computational time required for executing the task; and
(c2) for each of the plurality of tasks, updating a degree of importance associated with the task based on a monitoring result of (c1),
wherein, for each of the plurality of tasks, the degree of importance associated with the task is based on a relative value for at least one of the computational resources and computational time required for executing the task.

5. The non-transitory computer readable medium according to claim 4,
wherein, for each of the plurality of tasks, importance or confidentiality of processing according to the task is further reflected in the degree of importance associated with the task.

6. The non-transitory computer readable medium according to claim 1,
wherein selection in (a1) is selection based on a policy which specifies at least one of a quorum of participant nodes which become transmission destinations of an approval request, owners of participant nodes, loads of participant nodes, degrees of importance of tasks and communication delay of participant nodes, in addition to the reputation respectively associated with the participants node of the distributed computing system.

7. The non-transitory computer readable medium according to claim 1, wherein the computer program further causing the computer to execute
(D) approval processing including the following (d1) to (d3) in the case where an approval request which is a request for executing the processing target task is received:
(d1) judging whether or not reputation associated with a participant node which is a transmission source of the approval request is equal to or larger than a threshold;
(d2) in the case where a judgment result of (d1) is true, executing the task according to the approval request and returning a response including an execution result of the task; and
(d3) in the case where a judgement result of (d1) is false, not executing processing according to the approval request.

8. The non-transitory computer readable medium according to claim 7,
wherein, in (d3), a response including information indicating a failure of processing is returned.

9. The non-transitory computer readable medium according to claim 1, wherein the computer program further causing the computer to execute
settlement processing which is processing of paying to a designated participant a reward based on reputation associated with a participant node of the participant as the processing asynchronous with the requesting processing.

10. The non-transitory computer readable medium according to claim 1,
wherein the task is a smart contract.

11. The non-transitory computer readable medium according to claim 1, wherein the computer program further causing the computer to execute
reputation updating processing of updating reputation of each participant node managed by the computer based on the reputation of each participant node managed by a participant node other than the computer.

12. A distributed computing system comprising a plurality of participant nodes which are a plurality of computers,
wherein each of the plurality of participant nodes is configured to executes
(A) requesting processing which is processing including the following (a1) to (a4) every time a request is received:
(a1) selecting one or more participant nodes which are to be made request destinations of execution of a processing target task based on reputation respectively associated with participant nodes which participate in the distributed computing system and which are computers including the computers;
(a2) transmitting an approval request which is a request for executing the processing target task to each of the selected one or more participant nodes;
(a3) accepting from each of the one or more participant nodes, an approval response which is a response to the approval request transmitted to the participant node and which is a response including a task execution result of the processing target task executed by the participant node; and
(a4) returning a response to the request based on the number of correct task execution results, and
(B) reputation updating processing which is the following processing in at least one of the requesting processing and processing asynchronous with the requesting processing,
relatively increasing reputation associated with a participant node which transmits a response including a correct task execution result based on a degree of importance associated with a task corresponding to the task execution result.

13. A distributed computing method, comprising:
executing by a computer which participates in a distributed computing system
(A) requesting processing which is processing including the following (a1) to (a4) every time a request is received:
(a1) selecting one or more participant nodes which are to be made request destinations of a processing target task based on reputation respectively associated with participant nodes which participate in the distributed computing system and which are computers including the computer;
(a2) transmitting an approval request which is a request for executing the processing target task to each of the selected one or more participant nodes;
(a3) accepting from each of the one or more participant nodes, an approval response which is a response to the approval request transmitted to the participant node and which is a response including a task execution result of the processing target task executed by the participant node; and
(a4) returning a response to the request based on the number of correct task execution results, and
(B) reputation updating processing which is the following processing in at least one of the requesting processing and processing asynchronous with the requesting processing,
relatively increasing reputation associated with a participant node which transmits a response including a correct task execution result based on a degree of importance associated with a task corresponding to the task execution result.
